(19) United States
(12) Patent Application Publication
(10) Pub. No.: US 2023/0379071 A1
(43) Pub. Date: Nov. 23, 2023

(54) TIME-BASED APPLICATION OF PATH LOSS ESTIMATION

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/247,994

(22) PCT Filed: Dec. 30, 2020
(86) PCT No.: PCT/CN2020/141202

§ 371 Date: Apr. 5, 2023

(51) Int. Cl. H04B 17/309; H04W 72/542; H04W 52/24; H04W 72/20

(52) U.S. Cl. CPC H04B 17/347; H04W 72/542; H04W 52/242; H04W 72/20

(57) ABSTRACT

Various aspects of the present disclosure generally relate to wireless communication. In some aspects, a user equipment (UE) may receive, from a base station, a path loss reference signal indication for determining a time of occurrence of an occasion associated with applying a path loss estimation. The UE may apply the path loss estimation at a time determined based at least in part on the time of occurrence of the occasion. Numerous other aspects are provided.

### FIELD OF THE DISCLOSURE

Aspects of the present disclosure generally relate to wireless communication and to techniques and apparatuses for time-based application of path loss estimation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a base station, a path loss reference signal indication for determining a time of occurrence of an occasion associated with applying a path loss estimation; and applying the path loss estimation at a time (e.g., application time) determined based at least in part on the time of occurrence of the occasion.

In some aspects, a UE for wireless communication includes a memory and one or more processors operatively coupled to the memory, the memory and the one or more processors configured to: receive, from a base station, a path loss reference signal indication for determining a time of occurrence of an occasion associated with applying a path loss estimation; and apply the path loss estimation at a time (e.g., application time) determined based at least in part on the time of occurrence of the occasion.

In some aspects, a non-transitory computer-readable medium storing a set of instructions for wireless communication includes one or more instructions that, when executed by one or more processors of a UE, cause the UE to: receive, from a base station, a path loss reference signal indication for determining a time of occurrence of an occasion associated with applying a path loss estimation; and apply the path loss estimation at a time (e.g., application time) determined based at least in part on the time of occurrence of the occasion.

In some aspects, an apparatus for wireless communication includes means for receiving, from a base station, a path loss reference signal indication for determining a time of occurrence of an occasion associated with applying a path loss estimation; and means for applying the path loss estimation at a time (e.g., application time) determined based at least in part on the time of occurrence of the occasion.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example associated with time-based application of path loss estimation, in accordance with various aspects of the present disclosure.

FIG. 4 is a diagram illustrating an example associated with time-based application of path loss estimation, in accordance with various aspects of the present disclosure.

FIG. 5A and FIG. 5B are diagrams illustrating examples associated with time-based application of path loss estimation, in accordance with various aspects of the present disclosure.

FIG. 6 is a diagram illustrating an example process associated with time-based application of path loss estimation, in accordance with various aspects of the present disclosure.

FIG. 7 is a diagram illustrating an example apparatus associated with time-based application of path loss estimation, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

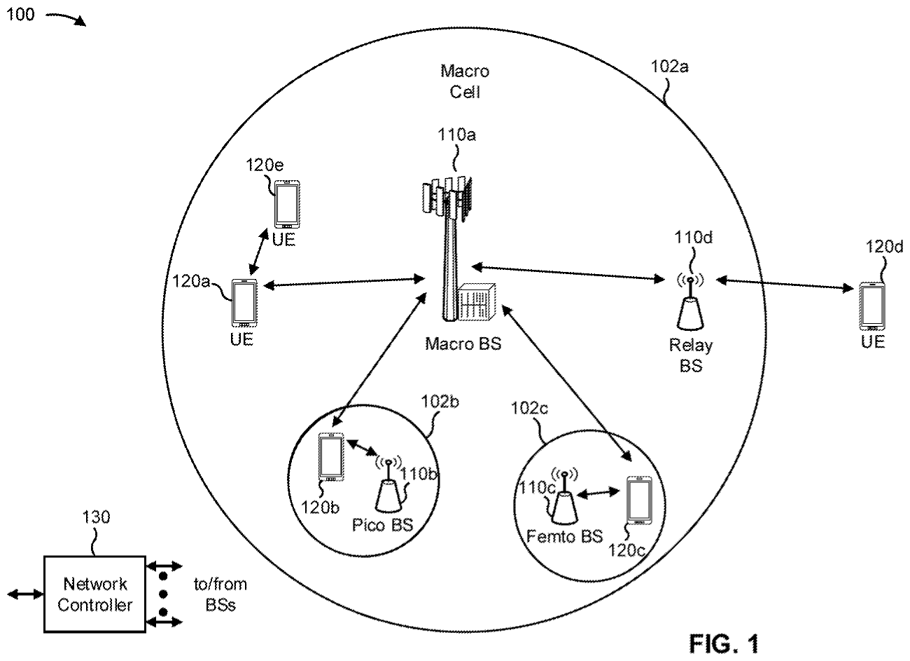

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

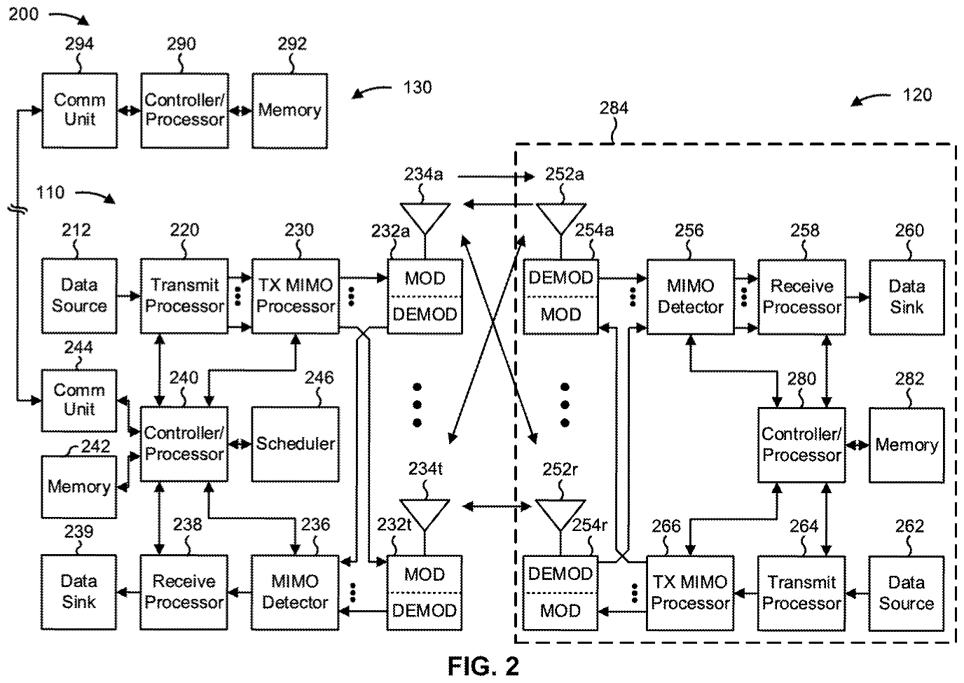

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

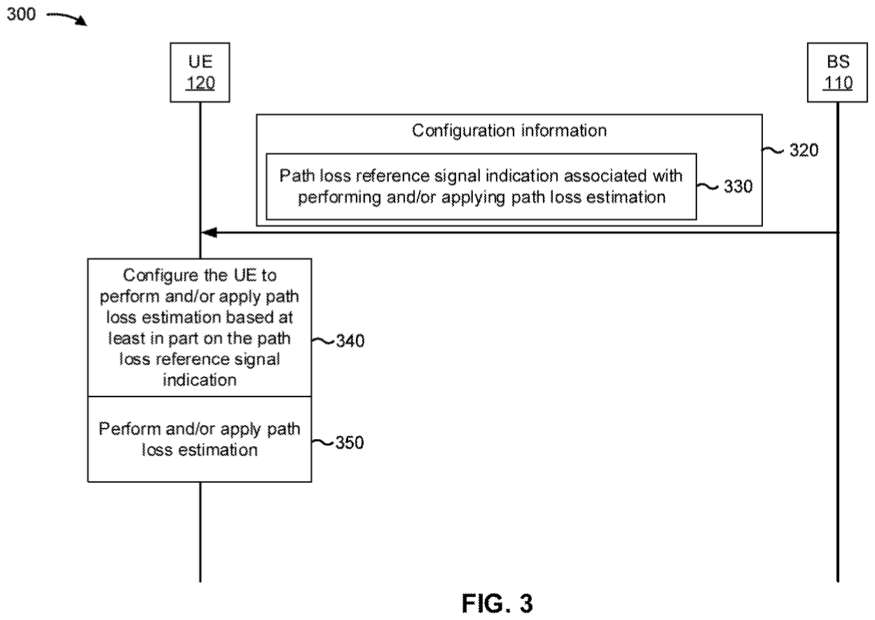

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-7.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-7.

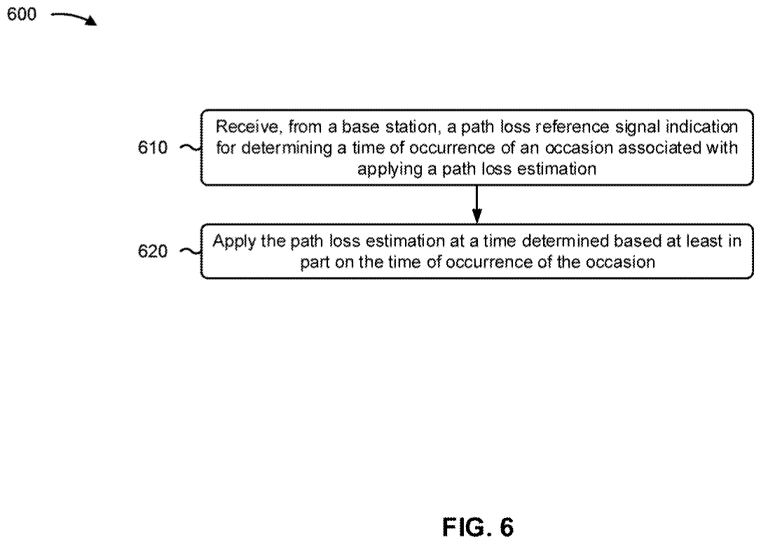

Controller/processor 240 of base station 110, controller/processor 280 of UE 120, and/or any other component(s) of FIG. 2 may perform one or more techniques associated with time-based application of path loss estimation, as described in more detail elsewhere herein. For example, controller/processor 240 of base station 110, controller/processor 280 of UE 120, and/or any other component(s) of FIG. 2 may perform or direct operations of, for example, process 600 of FIG. 6 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6 and/or other processes as described herein. In some aspects, executing instructions may include running the instructions, converting the instructions, compiling the instructions, and/or interpreting the instructions, among other examples.

In some aspects, a UE (e.g., UE 120) includes means for receiving, from a base station, a path loss reference signal indication for determining a time of occurrence of an occasion associated with applying a path loss estimation; and means for applying the path loss estimation at a time determined based at least in part on the time of occurrence of the occasion. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for determining the time of occurrence of the occasion associated with applying the path loss estimation.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

A UE may conduct data communication with a BS in a wireless network such as an LTE network or a 5G/NR network. The data communication may include downlink communications from the BS to the UE and may include uplink communications from the UE to the BS. During the data communication, the BS may decide to change a transmit-power configuration associated with the UE transmitting the uplink communications, and may transmit, via the downlink communications, a path loss reference signal indication for the UE to perform and/or apply path loss estimation associated with determining a transmit power to transmit the uplink communications.

In some aspects, the BS may transmit the path loss reference signal indication via a physical downlink control channel (PDCCH). Based on receiving the path loss reference signal indication, the UE may transmit an acknowledgment message (e.g., ACK) during a timeslot (e.g., ACK timeslot) associated with a physical uplink control channel (PUCCH) and/or a physical uplink shared channel (PUSCH) (referred to as PUCCH/PUSCH). In some aspects, the UE may perform path loss estimation after transmitting the acknowledgment message during the ACK timeslot and may apply the path loss estimation during a subsequent timeslot, which occurs at a given number of timeslots after the ACK timeslot. The UE may apply the path loss estimation by, for example, adjusting a transmission power associated with uplink communications to enable the BS to adequately receive the uplink communications during the subsequent timeslot.

In some cases, PDCCH repetition and PUCCH/PUSCH repetition may be supported. PDCCH repetition may be associated with the BS repeating transmission of the path loss reference signal indication via downlink control information (DCI) and/or via a medium access control control element (MAC CE). In an example, the BS may repeat transmission of the DCI by transmitting the same DCI (e.g., same payload) including the path loss reference signal indication in a plurality of search spaces and/or a control resource set (CORESET) associated with the PDCCH. In another example, the BS may repeat transmission of the MAC CE to update a reference signal (RS) resource utilized by the UE for path loss estimation or to provide beam information (e.g., a value for pucch-SpatialRelationlnfold) indicating the path loss reference signal indication. PUCCH/PUSCH repetition may be associated with the UE repeating transmission of the acknowledgment message by transmitting the same acknowledgment message on a plurality of occasions.

The plurality of occasions of transmission of the same acknowledgment message may span a plurality of timeslots. For instance, a first occasion of transmission of the acknowledgment message may be during a first ACK timeslot and the second occasion of transmission of the acknowledgment message may be during a second ACK timeslot. In this case, the UE may apply the path loss estimation during a first subsequent timeslot, which occurs a given number of timeslots after the first ACK timeslot, or during a second subsequent timeslot, which occurs the given number of timeslots after the second ACK timeslot. In some cases, the UE may randomly choose a subsequent timeslot (e.g., first subsequent timeslot or second subsequent timeslot) to apply the path loss estimation.

Because the BS may be unaware as to whether the UE may apply the path loss during the first subsequent timeslot or during the second subsequent timeslot, the BS may fail to adequately receive the uplink communications. For instance, if the BS expects to adequately receive the uplink communications during the first subsequent timeslot and the UE adjusts the transmission power associated with the uplink communications during the second subsequent timeslot, the BS may fail to adequately receive the uplink communications during the first subsequent timeslot. As a result, a measure of quality associated with a connection between the UE and the BS may fail to satisfy a threshold level (e.g., the measure of quality is lower than the threshold level), and the data communication between the UE and the BS may experience an interruption or a stoppage.

Various aspects of techniques and apparatuses describe herein may provide for time-based application of path loss estimation, which may include determining a time associated with performing and/or applying the path loss estimation. In some aspects, a UE may receive, from a BS, path loss reference signal indication for determining an occasion associated with the UE applying the path loss estimation, and may apply the path loss estimation at a time determined based at least in part on a time of occurrence of the occasion. Because the time when the UE is to apply the path loss estimation is based at least part on a rule associated with the time of occurrence of the occasion pre-known to the BS, the BS may be aware of the time when the UE applies the path loss estimation. As a result, the BS may adequately receive uplink communications from the UE during a timeslot associated with the time when the UE applies the path loss estimation. In this way, a measure of quality associated with a connection between the UE and the BS may satisfy a threshold level (e.g., the measure of quality is equal to or greater than the threshold level), and the data communication between the UE and the BS may continue uninterrupted. Also, UE resources (e.g., processing resources, memory space, power consumption, or the like) and network resources (e.g., bandwidth, management resources, processing resources, or the like) which would be utilized in connection with addressing an interruption or a stoppage may be utilized for other tasks, thereby enabling efficient utilization of such UE resources and network resources.

FIG. 3 is a diagram illustrating an example 300 associated with time-based application of path loss estimation, in accordance with various aspects of the present disclosure. FIG. 3 shows a UE 120 and a BS 110 conducting data communication in, for example, an LTE network or a 5G/NR network. The data communication may include downlink communications from the BS 110 to the UE 120 and may include uplink communications from the UE 120 to the BS 110. For instance, as discussed below in further detail, the downlink communications may include path loss reference signal indication for the UE 120 to utilize to perform and/or apply path loss estimation. In some aspects, the UE 120 may perform and/or apply the path loss estimation by transmitting an uplink communication at a transmission power determined based at least in part on performing the path loss estimation.

As shown by reference number 320, the BS 110 may transmit, and the UE 120 may receive, configuration information at a beginning of and/or during the data communication. In some aspects, the UE 120 may receive the configuration information from a device other than BS 110 (e.g., from another base station). In some aspects, the UE 120 may receive the configuration information via, for example, a control channel (e.g., a PDCCH) established between the UE 120 and the BS 110. The configuration information may be communicated via radio resource control (RRC) signaling, medium access control (MAC) signaling (e.g., MAC CE), downlink control information (DCI), or a combination thereof (e.g., RRC configuration of a set of values for a parameter and DCI indication of a selected value of the parameter).

In some aspects, the configuration information may include information associated with, for example, one or more configuration parameters for the UE 120 to use to configure the UE 120 for the data communication. For instance, as shown by reference number 330, the configuration information may include path loss reference signal indication associated with configuring the UE 120 to perform and/or apply path loss estimation. As shown by reference number 340, based at least in part on the configuration information, the UE 120 may configure the UE 120 to perform and/or apply the path loss estimation.

Based at least in part on the path loss reference signal indication, the UE 120 may configure the UE 120 to perform and/or apply the path loss estimation. In some aspects, the path loss reference signal indication may include a path loss activation command (e.g., MAC CE and/or DCI) to indicate that the UE 120 is to perform and/or apply the path loss estimation. In some aspects, in a situation where PUCCH/PUSCH repetition is supported, an application time (e.g., timeslot) for performing and/or applying the path loss estimation, based at least in part on the path loss reference signal indication, may be determined based on a timeslot. For instance, the application time for performing and/or applying the path loss estimation may be determined based on a timeslot associated with the UE 120 transmitting an acknowledgment message (e.g., ACK) to the BS 110. In some aspects, the UE 120 may transmit the acknowledgment message based at least in part on receiving the path loss reference signal indication. In some aspects, the UE 120 may transmit the acknowledgment message via the PUCCH/PUSCH.

In some aspects, the UE 120 may determine the application time based at least in part on occurrence of an occasion related to transmission of a first nominal acknowledgment message or based at least in part on occurrence of an occasion related to transmission of a second nominal acknowledgment message, the first nominal acknowledgment message and the second nominal acknowledgment message being associated with PUCCH/PUSCH repetition. In other words, the second nominal acknowledgment message may be associated with a repeated transmission (i.e., a repetition) of the first nominal acknowledgment message. Similarly, the UE 120 may determine the application time based at least in part on occurrence of an occasion related to transmission of a first actual acknowledgment message or based at least in part on occurrence of an occasion related to transmission of a second actual acknowledgment message, the first actual acknowledgment message and the second actual acknowledgment message being associated with PUCCH/PUSCH repetition. In other words, the second actual acknowledgment message may be associated with a repeated transmission (i.e., a repetition) of the first actual acknowledgment message. An occasion related to transmission of a nominal acknowledgment message may be associated with an occasion when the UE 120 is indicated to transmit the acknowledgement message but due to some reason such as, for example, a slot format conflict, and UE does not actually transmit the acknowledgment message. An occasion related to transmission of an actual acknowledgment message may be associated with an occasion when the UE 120 transmits the acknowledgment message.

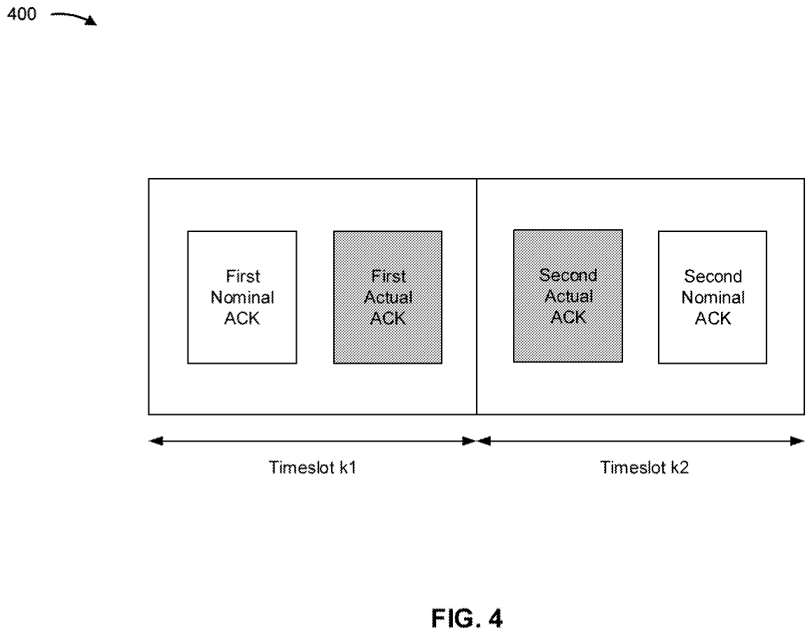

For instance, as shown in example 400 of FIG. 4, an occasion related to transmission of the first nominal acknowledgment message (e.g., first nominal ACK) and/or an occasion related to transmission of the first actual acknowledgment message (e.g., first actual ACK) may be during timeslot k1. Similarly, an occasion related to transmission of the second nominal acknowledgment message (e.g., second nominal ACK) and/or an occasion related to transmission of the second actual acknowledgment message (e.g., second actual ACK) may be during timeslot k2.

In some aspects, the UE 120 may determine the application time based at least in part on transmission of the first nominal acknowledgment message or based at least in part on transmission of the first actual acknowledgment message. In this case, the UE 120 may determine to perform and/or apply the path loss at the application time associated with a time of occurrence of transmission of the first nominal acknowledgment message or with transmission of the first actual acknowledgment message. In other words, the UE 120 may determine to perform and/or apply the path loss estimation at the application time associated with timeslot k1. In some aspects, the UE 120 may perform and/or apply the path loss estimation during a subsequent timeslot, with respect to timeslot k1, determined using the relationship k1+3·Nₛₗₒₜ^{subframe,μ}, where k1 represents the timeslot k1 during which the UE 120 may transmit the first nominal acknowledgment message or the first actual acknowledgment message and μ represents a subcarrier spacing (SCS) configuration for the PUCCH/PUSCH. Nₛₗₒₜ^{subframe,μ} is the number of slots in a subframe associated with the SCS configuration μ.

In some aspects, the UE 120 may determine the application time based at least in part transmission of the second nominal acknowledgment message or based at least in part on transmission of the second actual acknowledgment message. In this case, the UE 120 may determine that the UE 120 is to perform and/or apply the path loss at the application time associated with a time of occurrence of transmission of the second nominal acknowledgment message or associated with transmission of the second actual acknowledgment message. In other words, the UE 120 may determine that the UE 120 is to perform and/or apply the path loss estimation at the application time associated with timeslot k2. In some aspects, the UE 120 may perform and/or apply the path loss estimation during a subsequent timeslot, with respect to timeslot k2, determined using the relationship k2+3·Nₛₗₒₜ^{subframe,μ}, where k2 represents the timeslot k2 during which the UE 120 may transmit the second nominal acknowledgment message or the second actual acknowledgment message and μ represents an SCS configuration for the PUCCH/PUSCH.

In some aspects the UE 120 may determine the application time based at least in part on a time (e.g., timeslot) related to occurrence of an occasion associated with one or more of a transmission configuration indicator (TCI) state identifier, a closed loop index, an antenna panel identifier, a transmission-reception point (TRP) identifier, a sounding reference signal (SRS) set identifier, or spatial relation information (SRI).

In some aspects, the UE 120 may receive TCI state information including beam information associated with the PUCCH/PUSCH repetition. The TCI state information may include a TCI state identifier (TCI state ID) associated with a given timeslot. In some aspects, the given timeslot may be a timeslot during which the TCI state ID is received. The path loss reference signal indication may be associated with a time of occurrence associated with the TCI state ID (e.g., timeslot during which the TCI state ID is received). Further, the UE 120 may determine the application time in association with a first (e.g., smallest) TCI state ID or in association with a second (e.g., largest) TCI state ID. For instance, when the path loss reference signal indication indicates that the UE 120 is to perform and/or apply the path loss estimation, the UE 120 may perform and/or apply the path loss estimation at the application time during a timeslot in association with occurrence of the first TCI state ID. In some aspects, when the path loss reference signal indication indicates that the UE 120 is to perform and/or apply the path loss estimation, the UE 120 may perform and/or apply the path loss estimation at the application time during another timeslot in association with occurrence of the second TCI state ID. In some aspects the UE may determine the application time frame timeslot using the relationship k+3·Nₛₗₒₜ^{subframe,μ}, where k represents the given timeslot and μ represents an SCS configuration for the PUCCH/PUSCH. The TCI state can be any of the following types. Type 1: Joint DL/UL common TCI state to indicate a common beam for at least one DL channel/RS as plus at least one UL channel/RS. Type 2: Separate DL common TCI state to indicate a common beam for at least two DL channel or RS.Type 3: Separate UL common TCI state to indicate a common beam for at least two UL channel or RS.Type 4: Separate DL single channel/RS TCI state to indicate a beam for a single DL channel or RS. Type 5: Separate UL single channel/RS TCI state to indicate a beam for a single UL channel or RS. The source reference signal in the indicated TCI state applicable DL channel or RS reception provides quasi-colocation (QCL) information for reception of PDSCH, PDCCH, CSI-RS CORESET. The source reference signal(s) in the indicated TCI state applicable UL channel or RS reception provide a reference for determining UL transmission spatial filter(s) to PUSCH, PUCCH or SRS.

In some aspects, the UE 120 may receive a closed loop index, as a power control parameter, associated with the PUCCH/PUSCH repetition. The closed loop index may be associated with a given timeslot. In some aspects, the given timeslot may be a timeslot during which the closed loop index is received. The UE 120 may determine the application time based at least in part on a time of occurrence associated with the closed loop index (e.g., a timeslot during which the closed loop index is received). Further, the UE 120 may determine the application time in association with a first (e.g., smallest) closed loop index or in association with a second (e.g., largest) closed loop index. For instance, when the path loss reference signal indication indicates that the UE 120 is to perform and/or apply the path loss estimation, the UE 120 may perform and/or apply the path loss estimation during the application time timeslot in association with occurrence of the first closed loop index. In some aspects, when the path loss reference signal indication indicates that the UE 120 is to perform and/or apply the path loss estimation, the UE 120 may perform and/or apply the path loss estimation during the application time timeslot in association with occurrence of the second closed loop index. In some aspects the UE may determine the application time timeslot using the relationship k+3·Nₛₗₒₜ^{subframe,μ}, where k represents the given timeslot and μ represents an SCS configuration for the PUCCH/PUSCH.

In some aspects, the BS 110 may be associated with a plurality of antenna panels to communicate with the UE 120, with each antenna panel having a respective panel ID. The UE 120 may receive antenna panel information associated with the PUCCH/PUSCH repetition. The antenna panel information may include an antenna panel identifier (panel ID), of an antenna panel from among the plurality of antenna panels, that may be associated with a given timeslot. In some aspects, the given timeslot may be a timeslot during which the panel ID is received. The path loss reference signal indication may be associated with a time of occurrence associated with the panel ID (e.g., a timeslot during which the panel ID is received). Further, the UE 120 may determine the application time in association with a first (e.g., smallest or explicit) panel ID or in association with a second (e.g., largest or implicit) panel ID. For instance, the UE 120 may determine the application time timeslot in association with occurrence of the first panel ID, and the UE 120 may perform and/or apply the path loss estimation during the application time associated with occurrence of the first panel ID. In some aspects, the UE 120 may determine the application time in association with occurrence of the second panel ID, and the UE 120 may perform and/or apply the path loss estimation during the application time associated with occurrence of the second panel ID. In some aspects the UE may determine the application time timeslot using the relationship k+3·Nₛₗₒₜ^{subframe,μ}, where k represents the given timeslot and μ represents an SCS configuration for the PUCCH/PUSCH.

In some aspects, the BS 110 may be associated with a plurality of transmission-reception points (TRPs), with each transmission-reception point (TRP) having a respective TRP ID. The UE 120 may receive TRP information regarding the plurality of TRPs associated with the PUCCH/PUSCH repetition. The TRP information may include a TRP identifier (TRP ID) of a TRP from among the plurality of TRPs, that may be associated with a given timeslot. In some aspects, a TRP ID may be implicitly indicated by an associated CORESET pool index. In some aspects, the given timeslot may be a timeslot during which the TRP ID is received. The path loss reference signal indication may be associated with a time of occurrence associated with the TRP ID (e.g., a timeslot during which the TRP ID is received). Further, the UE 120 may determine the application time in association with a first (e.g., smallest) TRP ID or in association with a second (e.g., largest) TRP ID. For instance, when the path loss reference signal indication indicates that the UE 120 is to perform and/or apply the path loss, the UE 120 may perform and/or apply the path loss estimation during the application time in association with occurrence of the first TRP ID. In some aspects, when the path loss reference signal indication indicates that the UE 120 is to perform and/or apply the path loss, the UE 120 may perform and/or apply the path loss estimation during the application time in association with occurrence of the second TRP ID. In some aspects the UE may determine the application time timeslot using the relationship k+3·Nₛₗₒₜ^{subframe,μ}, where k represents the given timeslot and μ represents an SCS configuration for the PUCCH/PUSCH.

In some aspects, the UE 120 may receive sounding reference signal (SRS) information regarding codebook-based and/or non-codebook-based MIMO operations associated with the PUCCH/PUSCH repetition. The SRS information may include an SRS set identifier (SRS set ID) that may be associated with a given timeslot. In some aspects, the given timeslot may be a timeslot during which the SRS set ID is received. The path loss reference signal indication may be associated with a time of occurrence associated with the SRS set ID (e.g., a timeslot during which the SRS set ID is received). Further, the UE 120 may determine the application time in association with a first (e.g., smallest) SRS set ID or in association with a second (e.g., largest) SRS set ID. For instance, the UE 120 may determine the application time in association with occurrence of the first SRS set ID, and the UE 120 may perform and/or apply the path loss estimation during the application time associated with the occurrence of first SRS set ID. In some aspects, the UE 120 may determine the application time in association with the occurrence of the second SRS set ID, and the UE 120 may perform and/or apply the path loss estimation during the application associated with occurrence of the second SRS set ID. In some aspects the UE may determine the application time timeslot using the relationship k+3·Nₛₗₒₜ^{subframe,μ}, where k represents the given timeslot and μ represents an SCS configuration for the PUCCH/PUSCH.

In some aspects, the UE 120 may receive SRI including beam information associated with the PUCCH/PUSCH repetition. The SRI may include a spatial relation information identifier (SRI ID) that may be associated with a given timeslot. In some aspects, the given timeslot may be a timeslot during which the SRI ID is received. The path loss reference signal indication may be associated with information regarding a time of occurrence associated with an SRI ID (e.g., a timeslot during with the SRI ID is received). Further, the UE 120 may determine the application time in association with a first (e.g., smallest) SRI ID or in association with a second (e.g., largest) SRI ID. For instance, the UE 120 may determine the application time in association with occurrence of a given (e.g., the first for the second) SRI ID, the UE 120 may perform and/or apply the path loss estimation during an application time associated with occurrence of the given SRI ID. In some aspects the UE may determine the application time timeslot using the relationship k+3·Nₛₗₒₜ^{subframe,μ}, where k represents the given timeslot and μ represents an SCS configuration for the PUCCH/PUSCH.

In some aspects, the UE 120 may receive a plurality of values of SRI IDs associated with the PUCCH (e.g., pucch-SpatialRelationlnfold). The UE 120 may also receive, via a physical downlink shared channel (PDSCH), an activation command to perform and/or apply the path loss estimation. The activation command may include information indicating a given value of an SRI ID, from among the plurality of values of SRI IDs. In this case, the UE 120 may transmit an acknowledgment message, to acknowledge receipt of the activation command, via uplink control information on the PUSCH when the PUCCH for carrying the acknowledgment message for the PDSCH overlaps in time with the PUSCH.

If a reference signal (RS) resource updated by MAC CE is one from the RS resources the UE 120 maintains for path loss estimation for PUSCH/PUCCH/SRS transmissions, the UE 120 applies the path loss estimation based on the RS resources starting from the first slot that is after slot k+3·Nₛₗₒₜ^{subframe,μ}, where k is the slot where the UE 120 would transmit a first symbol of the first nominal repetition of PUCCH or PUSCH, if any repetition, with HARQ-ACK information for the PDSCH providing the MAC CE, and μ is the SCS configuration for the PUCCH or PUSCH, respectively.

If the UE 120 is provided more than one values for pucch-SpatialRelationlnfold and the UE receives an activation command [11, TS 38.321] indicating a value of pucch-SpatialRelationlnfold, the UE determines the referenceSignal value in PUCCH-PathlossReferenceRS through the link to a corresponding pucch-PathlossReferenceRS-Id index. The UE applies the activation command in the first slot that is after slot k+3·Nₛₗₒₜ^{subframe,μ}, where k is the slot where the UE would transmit a first symbol of the first nominal repetition of PUCCH or PUSCH, if any repetition with HARQ-ACK information for the PDSCH providing the activation command, and μ is the SCS configuration for the PUCCH or PUSCH.

In some aspects, the occasion associated with transmission of an actual acknowledgment message or a nominal acknowledgment message may span two timeslots. In this case, the UE 120 may determine the application time in association with a time of occurrence (e.g., timeslot) associated with a starting symbol of the actual acknowledgment message or a starting symbol of the nominal acknowledgment message. Alternatively, the UE 120 may determine the application time in association with a time of occurrence (e.g., timeslot) associated with an ending symbol of the actual acknowledgment message (or an ending symbol of the nominal acknowledgment message).

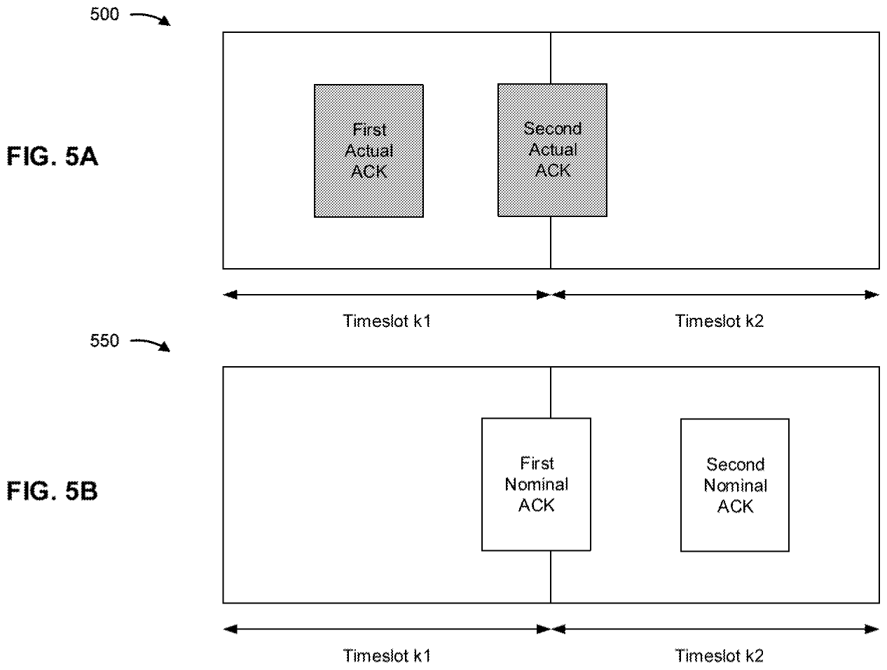

For instance, with respect to example 500 of FIG. 5A, which shows the occasion associated with transmission of the second actual acknowledgment message spanning timeslot k1 and timeslot k2, based at least in part on receiving the path loss reference signal indication, the UE 120 may perform and/or apply the path loss estimation in association with timeslot k1 associated with a starting symbol of the second actual acknowledgment message. Alternatively, based at least in part on receiving the path loss reference signal indication, the UE 120 may perform and/or apply the path loss estimation in association with timeslot k2 associated with an ending symbol of the second actual acknowledgment message. Similarly, with respect to example 550 of FIG. 5B, which shows the occasion associated with transmission of the first nominal acknowledgment message spanning timeslot k1 and timeslot k2, based at least in part on receiving the path loss reference signal indication, the UE 120 may perform and/or apply the path loss estimation in association with timeslot k1 associated with a starting symbol of the first nominal acknowledgment message. Alternatively, based at least in part on receiving the path loss reference signal indication, the UE 120 may perform and/or apply the path loss estimation in association with timeslot k2 associated with an ending symbol of the first nominal acknowledgment message.

In some aspects, the UE 120 may determine the application time based at least in part on an occasion associated with the PDCCH (e.g., a PDCCH occasion). In some aspects, the path loss reference signal indication may include a path loss activation command (e.g., MAC CE and/or DCI) to indicate that the UE 120 is to perform and/or apply the path loss estimation. For instance, when PDCCH repetition is supported, the UE 120 may determine the application time based at least in part on passage of a predetermined duration of time after occurrence of the PDCCH occasion (e.g., a predetermined number of symbols after a given symbol associated with the PDCCH occasion). In some aspects, the UE 120 may determine the application time (e.g., symbol) based at least in part in association with occurrence of the PDCCH occasion. The predetermined duration of time (e.g., the predetermined number of symbols) may be preconfigured by, for example, the BS 110 and may be included in the path loss reference signal indication received by the UE 120.

In some aspects, the UE 120 may be configured to determine the time (e.g., symbol) associated with occurrence of the PDCCH occasion based at least in part on occurrence of an occasion associated with a given CORESET pool index (e.g., symbol during which the given CORESET pool index is received). The given CORESET pool index may be associated with a TRP being utilized by the BS 110. Based at least in part on receiving the path loss reference signal indication, the UE 120 may perform and/or apply the path loss estimation in association with occurrence of a first (e.g., lowest) CORESET pool index or a second (e.g., highest) CORESET pool index when, for example, two PDCCH occasions are associated with coresets having different CORESET pool index values. Based at least in part on receiving the path loss reference signal indication, the UE 120 may perform and/or apply the path loss estimation in association with occurrence of the given (e.g., the first or the second) CORESET pool index. In some aspects, the UE 120 may perform and/or apply the path loss estimation based at least in part on passage of the predetermined duration of time after occurrence of the given CORESET pool index (e.g., a predetermined number of symbols after a given symbol during which the given CORESET pool index is received).

In some aspects, the UE 120 may be configured to determine the time (e.g., symbol) associated with occurrence of the PDCCH occasion based at least in part on occurrence of an occasion associated with a given CORESET ID (e.g., a symbol during which the given CORESET ID is received). Based at least in part on receiving the path loss reference signal indication, the UE 120 may perform and/or apply the path loss estimation in association with occurrence of a first (e.g., lowest) CORESET ID or a second (e.g., highest) CORESET ID when, for example, two PDCCH occasions are associated with different CORESET ID values. Based at least in part on receiving the path loss reference signal indication, the UE 120 may perform and/or apply the path loss estimation in association with occurrence of the given (e.g., the first or the second) CORESET ID. In some aspects, the UE 120 may perform and/or apply the path loss estimation based at least in part on passage of the predetermined duration of time after occurrence of the given CORESET ID (e.g., a predetermined number of symbols after a given symbol during which the given CORESET ID is received).

In some aspects, the UE 120 may be configured to determine the time (e.g., symbol) associated with occurrence of the PDCCH occasion based at least in part on occurrence of an occasion associated with a given search space ID (e.g., a symbol during which the given search space ID is received). Based at least in part on receiving the path loss reference signal indication, the UE 120 may perform and/or apply the path loss estimation in association with occurrence of a first (e.g., lowest) search space ID or a second (e.g., highest) search space ID when, for example, two PDCCH occasions are associated with different search space ID values. Based at least in part on receiving the path loss reference signal indication, the UE 120 may perform and/or apply the path loss estimation in association with occurrence of the given (e.g., the first or the second) search space ID. In some aspects, the UE 120 may perform and/or apply the path loss estimation based at least in part on passage of the predetermined duration of time after occurrence of the given search space ID (e.g., a predetermined number of symbols after a given symbol during which the given search space ID is received).

In some aspects, the UE 120 may be configured to determine the time (e.g., symbol) associated with occurrence of the PDCCH occasion based at least in part on occurrence of an occasion associated with a given monitoring occasion associated with the PDCCH. Based at least in part on receiving the path loss reference signal indication, the UE 120 may perform and/or apply the path loss estimation in association with occurrence of a first (e.g., earliest) monitoring occasion or a second (e.g., latest) monitoring occasion when, for example, two PDCCH occasions are associated with different monitoring occasions. Based at least in part on receiving the path loss reference signal indication, the UE 120 may perform and/or apply the path loss estimation in association with occurrence of the given (e.g., the first or the second) monitoring occasion. In some aspects, the UE 120 may perform and/or apply the path loss estimation based at least in part on passage of the predetermined duration of time after occurrence of the given monitoring occasion (e.g., a predetermined number of symbols after a given symbol associated with the given monitoring occasion).

In some aspects, the UE 120 may be configured to determine the time (e.g., symbol) associated with occurrence of the PDCCH occasion based at least in part on occurrence of an occasion associated with a given symbol associated with the PDCCH. Based at least in part on receiving the path loss reference signal indication, the UE 120 may perform and/or apply the path loss estimation in association with occurrence of a first (e.g., starting) symbol or a second (e.g., ending) symbol. Based at least in part on receiving the path loss reference signal indication, the UE 120 is to perform and/or apply the path loss estimation in association with occurrence of the given (e.g., the first or the second) symbol. In some aspects, the UE 120 may perform and/or apply the path loss estimation based at least in part on passage of the predetermined duration of time after occurrence of the given symbol).

In some aspects, the UE 120 may be configured to determine the time (e.g., symbol) associated with occurrence of the PDCCH occasion based at least in part on occurrence of an occasion associated with a given resource block index or a given resource element index (referred to as RB/RE index) associated with the PDCCH. Based at least in part on receiving the path loss reference signal indication, the UE 120 may perform and/or apply the path loss estimation in association with occurrence of a first (e.g., lowest) RB/RE index or a second (e.g., highest) RB/RE index when, for example, two PDCCH occasions are associated with indifferent RB/RE index values. Based at least in part on receiving the path loss reference signal indication, the UE 120 may perform and/or apply the path loss estimation in association with occurrence of the given (e.g., the first or the second) RB/RE index. In some aspects, the UE 120 may perform and/or apply the path loss estimation based at least in part on passage of the predetermined duration of time after occurrence of the given RB/RE index (e.g., a predetermined number of symbols after a given symbol associated with the given RB/RE index).

In some aspects, the UE 120 may be configured to determine the time (e.g., symbol) associated with occurrence of the PDCCH occasion based at least in part on occurrence of an occasion associated with a given candidate index, from among a plurality of candidate indices, associated with a planned detection in the PDCCH. Based at least in part on receiving the path loss reference signal indication, the UE 120 may perform and/or apply the path loss estimation in association with occurrence of a first (e.g., smallest) candidate index or a second (e.g., largest) candidate index when, for example, two PDCCH occasions are associated with different candidate index values. Based at least in part on receiving the path loss reference signal indication, the UE 120 may perform and/or apply the path loss estimation in association with occurrence of the given (e.g., the first or the second) candidate index. In some aspects, the UE 120 may perform and/or apply the path loss estimation based at least in part on passage of the predetermined duration of time after occurrence of the given candidate index (e.g., a predetermined number of symbols after a given symbol associated with the given candidate index).

In some aspects, the UE 120 may be configured to determine the time (e.g., symbol) associated with occurrence of the PDCCH occasion based at least in part on occurrence of an occasion associated with a given control channel element (CCE) index associated with, for example, a group of resource blocks or resource elements in the PDCCH. Based at least in part on receiving the path loss reference signal indication, the UE 120 may perform and/or apply the path loss estimation in association with occurrence of a first (e.g., smallest) CCE index or a second (e.g., largest) CCE index when, for example, two PDCCH occasions are associated with different CCE index values. Based at least in part on receiving the path loss reference signal indication, the UE 120 may perform and/or apply the path loss estimation in association with occurrence of the given (e.g., the first or the second) CCE index. In some aspects, the UE 120 may perform and/or apply the path loss estimation based at least in part on passage of the predetermined duration of time after occurrence of the given CCE index (e.g., a predetermined number of symbols after a given symbol associated with the given CCE index).

In some aspects, the UE 120 may be configured to determine the time (e.g., symbol) associated with occurrence of the PDCCH occasion based at least in part on occurrence of an occasion associated with a given TCI state ID associated with, for example, a group of resource blocks or resource elements in the PDCCH. In some aspects, the occasion associated with occurrence of a given TCI state ID may be associated with a symbol during which the given TCI state ID is received. Based at least in part on receiving the path loss reference signal indication, the UE 120 may perform and/or apply the path loss estimation in association with occurrence of a first (e.g., lowest) TCI state ID or a second (e.g., highest) TCI state ID when, for example, two PDCCH occasions are associated with different TCI state IDs. Based at least in part on receiving the path loss reference signal indication, the UE 120 may perform and/or apply the path loss estimation in association with occurrence of the given (e.g., the first or the second) TCI state ID. In some aspects, the UE 120 may perform and/or apply the path loss estimation based at least in part on passage of the predetermined duration of time after occurrence of the given TCI state ID (e.g., a predetermined number of symbols after a given symbol during which the given TCI state ID is received).

In some aspects, the UE 120 may be configured to determine the time (e.g., symbol) associated with occurrence of the PDCCH occasion based at least in part on occurrence of an occasion associated with a TCI state ID that is quasi co-located with a given synchronization signal block (SSB) index associated with the PDCCH. Based at least in part on receiving the path loss reference signal indication, the UE 120 may perform and/or apply the path loss estimation in association with occurrence of a first (e.g., lowest) SSB index or a second (e.g., highest) SSB index when, for example, two PDCCH occasions are associated with different SSB indices. Based at least in part on receiving the path loss reference signal indication, the UE 120 may perform and/or apply the path loss estimation in association with occurrence of the given (e.g., the first or the second) SSB index. In some aspects, the UE 120 may perform and/or apply the path loss estimation based at least in part on passage of the predetermined duration of time after occurrence of the given SSB index (e.g., a predetermined number of symbols after a given symbol associated with the given SSB index).

In some aspects, the UE 120 may be configured to determine the time (e.g., symbol) associated with occurrence of the PDCCH occasion based at least in part on occurrence of an occasion associated with a TRP ID associated with the PDCCH. For instance, the TRP ID may be associated with a TRP utilized by the BS 110 to transmit, and by the UE 120 to receive, the PDCCH. In some aspects, the occasion associated with a given TRP ID may be associated with a symbol during which the given TRP ID is received. Based at least in part on receiving the path loss reference signal indication, the UE 120 may perform and/or apply the path loss estimation in association with occurrence of a first (e.g., lowest) TRP ID or a second (e.g., highest) TRP ID. Based at least in part on receiving the path loss reference signal indication, the UE 120 may perform and/or apply the path loss estimation in association with occurrence of the given (e.g., the first or the second) TRP ID. In some aspects, the UE 120 may perform and/or apply the path loss estimation based at least in part on passage of the predetermined duration of time after occurrence of the given TRP ID (e.g., a predetermined number of symbols after a given symbol during which the given TRP ID is received).

As shown by reference number 350 of FIG. 3, the UE 120 may perform and/or apply the path loss estimation, as discussed above, based at least in part on the path loss reference signal indication included in the configuration information. In some aspects, the UE 120 may utilize internal resources such as, for example, the controller/processor 280 and/or the memory 282 to perform and/or apply the path loss estimation.

By utilizing the time-based application of path loss estimation, as discussed herein, a BS may adequately receive uplink communications from a UE during a timeslot associated with the time when the UE is to perform and/or apply the path loss estimation. In this way, a measure of quality associated with a connection between the UE and the BS may satisfy a threshold level (e.g., the measure of quality is equal to or greater than the threshold level), and the data communication between the UE and the BS may continue uninterrupted. Also, UE resources (e.g., processing resources, memory space, power consumption, or the like) and network resources (e.g., bandwidth, management resources, processing resources, or the like) utilized in connection with addressing an interruption or a stoppage may be utilized for other tasks, thereby enabling efficient utilization of such UE resources and network resources.

As indicated above, FIG. 3 is provided as an example. Other examples may differ from what is described with regard to FIG. 3.

FIG. 6 is a diagram illustrating an example process 600 performed, for example, by a UE (e.g., UE 120), in accordance with various aspects of the present disclosure. Example process 600 is an example where the UE performs operations associated with time-based application of path loss estimation.

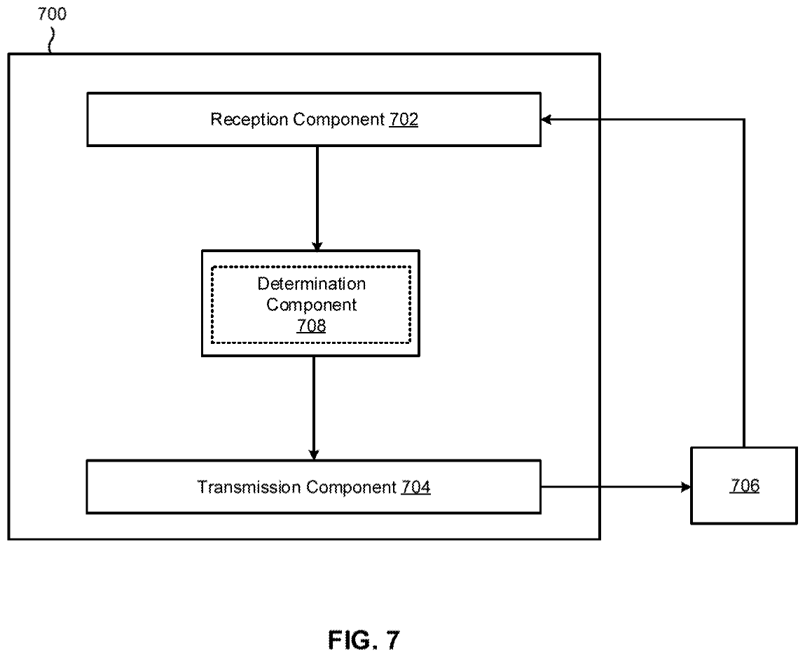

As shown in FIG. 6, in some aspects, process 600 may include receiving, from a base station, a path loss reference signal indication for determining a time of occurrence of an occasion associated with applying a path loss estimation (block 610). For example, the UE (e.g., using reception component 702, depicted in FIG. 7) may receive, from a base station, a path loss reference signal indication for determining a time of occurrence of an occasion associated with applying a path loss estimation, as described above.

As further shown in FIG. 6, in some aspects, process 600 may include applying the path loss estimation at a time determined based at least in part on the time of occurrence of the occasion (block 620). For example, the UE (e.g., using a determination component 708, depicted in FIG. 7) may apply the path loss estimation at a time determined based at least in part on the time of occurrence of the occasion, as described above.

Process 600 may include additional aspects, such as any single aspect or any combination of aspects described below and/or in connection with one or more other processes described elsewhere herein.

In a first aspect, process 600 includes determining the time of occurrence of the occasion associated with applying the path loss estimation.

In a second aspect, alone or in combination with the first aspect, applying the path loss estimation includes transmitting an uplink communication at a transmission power determined based at least in part on the path loss estimation.

In a third aspect, alone or in combination with one or more of the first and second aspects, receiving the path loss reference signal indication includes receiving a medium access control control element (MAC CE) or downlink control information (DCI).

In a fourth aspect, alone or in combination with one or more of the first through third aspects, the time of occurrence of the occasion is associated with a time of occurrence of a physical uplink control channel (PUCCH) occasion.

In a fifth aspect, alone or in combination with one or more of the first through fourth aspects, the time of occurrence of the occasion is associated with a time of occurrence of a physical uplink shared channel (PUSCH) occasion.

In a sixth aspect, alone or in combination with one or more of the first through fifth aspects, the time of occurrence of the occasion is associated with a time of occurrence of a transmission of a nominal acknowledgment message.

In a seventh aspect, alone or in combination with one or more of the first through fifth aspects, the time of occurrence of the occasion is associated with a time of occurrence of a transmission of an actual acknowledgment message.

In an eighth aspect, alone or in combination with one or more of the first through seventh aspects, the time of occurrence of the occasion is associated with a time of occurrence associated with a spatial relation information identifier, a transmission configuration indicator (TCI) state identifier, a closed loop index, an antenna panel identifier, a transmission-reception point (TRP) identifier, or a sounding reference signal (SRS) set identifier.

In a ninth aspect, alone or in combination with one or more of the first through eighth aspects, the time of occurrence of the occasion is associated with a time of occurrence of spatial relation information in a PUCCH.

In a tenth aspect, alone or in combination with one or more of the first through ninth aspects, the time of occurrence of the occasion is associated with a time of occurrence of a slot in which the UE transmits a first symbol of a first nominal repetition of a PUCCH or a PUSCH, if any repetition, with feedback information.

In an eleventh aspect, alone or in combination with one or more of the first through tenth aspects, the time of occurrence of the occasion is associated with a time of occurrence of a physical downlink control channel (PDCCH) occasion.

In a twelfth aspect, alone or in combination with one or more of the first through eleventh aspects, the time of occurrence of the occasion is associated with a time of occurrence of a CORESET pool index in a PDCCH.

In a thirteenth aspect, alone or in combination with one or more of the first through twelfth aspects, the time of occurrence of the occasion is associated with a time of occurrence of a CORESET identifier in a PDCCH.

In a fourteenth aspect, alone or in combination with one or more of the first through thirteenth aspects, the time of occurrence of the occasion is associated with a time of occurrence of a search space identifier in a PDCCH.

In a fifteenth aspect, alone or in combination with one or more of the first through fourteenth aspects, the time of occurrence of the occasion is associated with a time of occurrence of a monitoring occasion in a PDCCH.

In a sixteenth aspect, alone or in combination with one or more of the first through fifteenth aspects, the time of occurrence of the occasion is associated with a time of occurrence of a starting symbol or an ending symbol in a PDCCH.

In a seventeenth aspect, alone or in combination with one or more of the first through sixteenth aspects, the time of occurrence of the occasion is associated with a time of occurrence of a resource block or a resource element in a PDCCH.

In an eighteenth aspect, alone or in combination with one or more of the first through seventeenth aspects, the time of occurrence of the occasion is associated with a time of occurrence of a candidate index in a PDCCH.

In a nineteenth aspect, alone or in combination with one or more of the first through eighteenth aspects, the time of occurrence of the occasion is associated with a time of occurrence of a control channel element (CCE) index in a PDCCH.

In a twentieth aspect, alone or in combination with one or more of the first through nineteenth aspects, the time of occurrence of the occasion is associated with a time of occurrence of a TCI state identifier in a PDCCH.

In a twenty-first aspect, alone or in combination with one or more of the first through twentieth aspects, the time of occurrence of the occasion is associated with a time of occurrence of a TCI state identifier being quasi co-located with a synchronization signal block in a PDCCH.

In a twenty-second aspect, alone or in combination with one or more of the first through twenty-first aspects, the time of occurrence of the occasion is associated with a time of occurrence of a TRP identifier in a PDCCH.

In the twenty-third aspect, alone or in combination with one or more of the first through sixth aspects and the eighth through twenty-second aspects, when a nominal PUCCH occasion spans a plurality of slots, the time of occurrence of the occasion is associated with a time of occurrence of a slot associated with a starting symbol or an ending symbol of the nominal PUCCH occasion.

In the twenty-fourth aspect, alone or in combination with one or more of the first through sixth aspects and the eighth through twenty-second aspects, when a nominal PUSCH occasion spans a plurality of slots, the time of occurrence of the occasion is associated with a time of occurrence of a slot associated with a starting symbol or an ending symbol of the nominal PUSCH occasion.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include one or more of a determination component 708, among other examples.

In some aspects, the apparatus 700 may be configured to perform one or more operations described herein in connection with FIGS. 3-5B. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The reception component 702 may receive, from a base station, a path loss reference signal indication for determining a time of occurrence of an occasion associated with applying a path loss estimation. The determination component 708 may apply the path loss estimation at a time determined based at least in part on the time of occurrence of the occasion.

The determination component 708 may determine the time of occurrence of the occasion associated with applying the path loss estimation.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of aspects of the present disclosure:

Aspect 1: A method for wireless communication performed by a user equipment (UE), comprising: receiving, from a base station, a path loss reference signal indication for determining a time of occurrence of an occasion associated with applying a path loss estimation; and applying the path loss estimation at a time determined based at least in part on the time of occurrence of the occasion.

Aspect 2: The method of aspect 1, further comprising: determining the time of occurrence of the occasion associated with applying the path loss estimation.

Aspect 3: The method of any of aspects 1 through 2, wherein applying the path loss estimation includes transmitting an uplink communication at a transmission power determined based at least in part on the path loss estimation.

Aspect 4: The method of any of aspects 1 through 3, wherein receiving the path loss reference signal indication includes receiving a medium access control control element (MAC CE) or downlink control information (DCI).

Aspect 5: The method of any of aspects 1 through 4, wherein the time of occurrence of the occasion is associated with a time of occurrence of a physical uplink control channel (PUCCH) occasion.

Aspect 6: The method of any of aspects 1 through 5, The method of claim 26, wherein the time of occurrence of the occasion is associated with a time of occurrence of a physical uplink shared channel (PUSCH) occasion.

Aspect 7: The method of any of aspects 1 through 6, wherein the time of occurrence of the occasion is associated with a time of occurrence of a transmission of a nominal acknowledgment message.

Aspect 8: The method of any of aspects 1 through 6, wherein the time of occurrence of the occasion is associated with a time of occurrence of a transmission of an actual acknowledgment message.

Aspect 9: The method of any of aspects 1 through 8, wherein the time of occurrence of the occasion is associated with a time of occurrence associated with a spatial relation information identifier, a transmission configuration indicator (TCI) state identifier, a closed loop index, an antenna panel identifier, a transmission-reception point (TRP) identifier, or a sounding reference signal (SRS) set identifier.

Aspect 10: The method of any of aspects 1 through 9, wherein, when a nominal physical uplink control channel (PUCCH) occasion spans a plurality of slots, the time of occurrence of the occasion is associated with a time of occurrence of a slot associated with a starting symbol or an ending symbol of the nominal PUCCH occasion.

Aspect 11: The method of any of aspects 1 through 10, wherein, when a nominal physical uplink shared channel (PUSCH) occasion spans a plurality of slots, the time of occurrence of the occasion is associated with a time of occurrence of a slot associated with a starting symbol or an ending symbol of the nominal PUSCH occasion.

Aspect 12: The method of any of aspects 1 through 11, wherein the time of occurrence of the occasion is associated with a time of occurrence of spatial relation information in a physical uplink control channel (PUCCH).

Aspect 13: The method of any of aspects 1 through 12, wherein the time of occurrence of the occasion is associated with a time of occurrence of a slot in which the UE transmits a first symbol of a first nominal repetition of a physical uplink control channel (PUCCH) or a physical uplink shared channel (PUSCH), if any repetition, with feedback information.

Aspect 14: The method of any of aspects 1 through 13, wherein the time of occurrence of the occasion is associated with a time of occurrence of a physical downlink control channel (PDCCH) occasion.

Aspect 15: The method of any of aspects 1 through 14, wherein the time of occurrence of the occasion is associated with a time of occurrence of a CORESET pool index in a physical downlink control channel (PDCCH).

Aspect 16: The method of any of aspects 1 through 15, wherein the time of occurrence of the occasion is associated with a time of occurrence of a CORESET identifier in a physical downlink control channel (PDCCH).

Aspect 17: The method of any of aspects 1 through 16, wherein the time of occurrence of the occasion is associated with a time of occurrence of a search space identifier in a physical downlink control channel (PDCCH).

Aspect 18: The method of any of aspects 1 through 17, wherein the time of occurrence of the occasion is associated with a time of occurrence of a monitoring occasion in a physical downlink control channel (PDCCH).

Aspect 19: The method of any of aspects 1 through 18, wherein the time of occurrence of the occasion is associated with a time of occurrence of a starting symbol or an ending symbol in a physical downlink control channel (PDCCH).

Aspect 20: The method of any of aspects 1 through 19, wherein the time of occurrence of the occasion is associated with a time of occurrence of a resource block or a resource element in a physical downlink control channel (PDCCH).

Aspect 21: The method of any of aspects 1 through 20, wherein the time of occurrence of the occasion is associated with a time of occurrence of a candidate index in a physical downlink control channel (PDCCH).

Aspect 22: The method of any of aspects 1 through 21, wherein the time of occurrence of the occasion is associated with a time of occurrence of a control channel element (CCE) index in a physical downlink control channel (PDCCH).

Aspect 23: The method of any of aspects 1 through 22, wherein the time of occurrence of the occasion is associated with a time of occurrence of a transmission configuration indicator (TCI) state identifier in a physical downlink control channel (PDCCH).

Aspect 24: The method of any of aspects 1 through 23, wherein the time of occurrence of the occasion is associated with a time of occurrence of a transmission configuration indicator (TCI) state identifier being quasi co-located with a synchronization signal block in a physical downlink control channel (PDCCH).

Aspect 25: The method of any of aspects 1 through 24, wherein the time of occurrence of the occasion is associated with a time of occurrence of a transmission-reception point (TRP) identifier in a physical downlink control channel (PDCCH).

Aspect 26: An apparatus for wireless communication at a first device, comprising a processor; memory coupled with the processor; and instructions stored in the memory and executable by the processor to cause the apparatus to perform a method of any of aspects 1 through 25.

Aspect 27: A user equipment for wireless communication, comprising a memory and one or more processors coupled to the memory, the memory and the one or more processors configured to perform a method of any of aspects 1 through 25.

Aspect 28: An apparatus for wireless communication, comprising at least one means for performing a method of any of aspects 1 through 25.

Aspect 29: A non-transitory computer-readable medium storing code for wireless communication, the code comprising instructions executable by a processor to perform a method of any of aspects 1 through 25.

Aspect 30: A non-transitory computer-readable medium storing one or more instructions for wireless communication, the one or more instructions comprising one or more instructions that, when executed by one or more processors of a user equipment, cause the one or more processors to perform a method of any of aspects 1 through 25.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors operatively coupled to the memory, the memory and the one or more processors configured to:
receive, from a base station, a path loss reference signal indication for determining a time of occurrence of an occasion associated with applying a path loss estimation; and
apply the path loss estimation at a time determined based at least in part on the time of occurrence of the occasion.

2. The UE of claim 1, wherein the one or more processors are further configured to:
determine the time of occurrence of the occasion associated with applying the path loss estimation.

3. The UE of claim 1, wherein the one or more processors, when applying the path loss estimation, are configured to transmit an uplink communication at a transmission power determined based at least in part on the path loss estimation.

4. The UE of claim 1, wherein the one or more processors, when receiving the path loss reference signal indication, are configured to receive a medium access control control element (MAC CE) or downlink control information (DCI).

5. The UE of claim 1, wherein the time of occurrence of the occasion is associated with a time of occurrence of a physical uplink control channel (PUCCH) occasion.

6. The UE of claim 1, wherein the time of occurrence of the occasion is associated with a time of occurrence of a physical uplink shared channel (PUSCH) occasion.

7. The UE of claim 1, wherein the time of occurrence of the occasion is associated with a time of occurrence of a transmission of a nominal acknowledgment message.

8. The UE of claim 1, wherein the time of occurrence of the occasion is associated with a time of occurrence of a transmission of an actual acknowledgment message.

9. The UE of claim 1, wherein the time of occurrence of the occasion is associated with a time of occurrence associated with a spatial relation information identifier, a transmission configuration indicator (TCI) state identifier, a closed loop index, an antenna panel identifier, a transmission-reception point (TRP) identifier, or a sounding reference signal (SRS) set identifier.

10. The UE of claim 1, wherein, when a nominal physical uplink control channel (PUCCH) occasion spans a plurality of slots, the time of occurrence of the occasion is associated with a time of occurrence of a slot associated with a starting symbol or an ending symbol of the nominal PUCCH occasion.

11. The UE of claim 1, wherein, when a nominal physical uplink shared channel (PUSCH) occasion spans a plurality of slots, the time of occurrence of the occasion is associated with a time of occurrence of a slot associated with a starting symbol or an ending symbol of the nominal PUSCH occasion.

12. The UE of claim 1, wherein the time of occurrence of the occasion is associated with a time of occurrence of spatial relation information in a physical uplink control channel (PUCCH).

13. The UE of claim 1, wherein the time of occurrence of the occasion is associated with a time of occurrence of a slot in which the UE transmits a first symbol of a first nominal repetition of a physical uplink control channel (PUCCH) or a physical uplink shared channel (PUSCH), if any repetition, with feedback information.

14. The UE of claim 1, wherein the time of occurrence of the occasion is associated with a time of occurrence of a physical downlink control channel (PDCCH) occasion.

15. The UE of claim 1, wherein the time of occurrence of the occasion is associated with a time of occurrence of a CORESET pool index in a physical downlink control channel (PDCCH).

16. The UE of claim 1, wherein the time of occurrence of the occasion is associated with a time of occurrence of a CORESET identifier in a physical downlink control channel (PDCCH).

17. The UE of claim 1, wherein the time of occurrence of the occasion is associated with a time of occurrence of a search space identifier in a physical downlink control channel (PDCCH).

18. The UE of claim 1, wherein the time of occurrence of the occasion is associated with a time of occurrence of a monitoring occasion in a physical downlink control channel (PDCCH).

19. The UE of claim 1, wherein the time of occurrence of the occasion is associated with a time of occurrence of a starting symbol or an ending symbol in a physical downlink control channel (PDCCH).

20. The UE of claim 1, wherein the time of occurrence of the occasion is associated with a time of occurrence of a resource block or a resource element in a physical downlink control channel (PDCCH).

21. The UE of claim 1, wherein the time of occurrence of the occasion is associated with a time of occurrence of a candidate index in a physical downlink control channel (PDCCH).

22. The UE of claim 1, wherein the time of occurrence of the occasion is associated with a time of occurrence of a control channel element (CCE) index in a physical downlink control channel (PDCCH).

23. The UE of claim 1, wherein the time of occurrence of the occasion is associated with a time of occurrence of a transmission configuration indicator (TCI) state identifier in a physical downlink control channel (PDCCH).

24. The UE of claim 1, wherein the time of occurrence of the occasion is associated with a time of occurrence of a transmission configuration indicator (TCI) state identifier being quasi co-located with a synchronization signal block in a physical downlink control channel (PDCCH).

25. The UE of claim 1, wherein the time of occurrence of the occasion is associated with a time of occurrence of a transmission-reception point (TRP) identifier in a physical downlink control channel (PDCCH).

26. A method of wireless communication performed by a user equipment (UE), comprising:
receiving, from a base station, a path loss reference signal indication for determining a time of occurrence of an occasion associated with applying a path loss estimation; and
applying the path loss estimation at a time determined based at least in part on the time of occurrence of the occasion.

27. The method of claim 26, further comprising:
determining the time of occurrence of the occasion associated with applying the path loss estimation.

28. The method of claim 26, wherein applying the path loss estimation includes transmitting an uplink communication at a transmission power determined based at least in part on the path loss estimation.

29. The method of claim 26, wherein receiving the path loss reference signal indication includes receiving a medium access control element (MAC CE) or downlink control information (DCI).

30-50. (canceled)

51. A non-transitory computer-readable medium storing a set of instructions for wireless communication, the set of instructions comprising:
one or more instructions that, when executed by one or more processors of a user equipment (UE), cause the UE to:
receive, from a base station, a path loss reference signal indication for determining a time of occurrence of an occasion associated with applying a path loss estimation; and
apply the path loss estimation at a time determined based at least in part on the time of occurrence of the occasion.

52. (canceled)
